(19) United States
(12) Patent Application Publication
(10) Pub. No.: US 2016/0182264 A1
(43) Pub. Date: Jun. 23, 2016

(54) DIGITAL DECODING OF BACKSCATTER MODULATED DATA

(71) Applicant: FREESCALE SEMICONDUCTOR, INC., Austin, TX (US)

(72) Inventors: FEI CHEN, SHANGHAI (CN); GANG LI, SHANGHAI (CN)

(21) Appl. No.: 14/743,991

(22) Filed: Jun. 18, 2015

(30) Foreign Application Priority Data
Dec. 22, 2014 (CN) 201410858362.4

(51) Int. Cl. H04L 27/06; H04L 27/00; H04L 25/493; H04L 27/08

(52) U.S. Cl. CPC H04L 27/06; H04L 27/08; H04L 27/0002; H04L 25/493

(57) ABSTRACT

A digital Binary Amplitude Shift Keying (BASK) demodulator and decoder and method of decoding encoded BASK modulated signals, where the method samples peak amplitude values of a processed version of a modulated signal to provide sampled values that are digitized to form digitized values. The digitized values are stored in a sequence order based on an order in which the peak amplitude values corresponding to the digitized values were sampled. The digitized values are filtered using their sequence order to provide filtered modulated digital signals. Transitions of the first filtered modulated digital signal are identified during a data bit duration and decoded demodulated binary data streams are then selectively generated.

### BACKGROUND OF THE INVENTION

The present invention relates generally to wireless charging and, more particularly, to digital demodulation of backscatter modulated data and decoding of such data.

Backscatter used in conjunction with Binary Amplitude Shift Keying (BASK) modulation is a simple and cost effective approach for communicating data across relatively short distances. This approach relies on inductive coupling of a primary and secondary coil in which current in the secondary coil is BASK modulated. This modulated current affects the loading on the primary coil and therefore a BASK modulated signal is generated across the primary coil.

Demodulation and decoding of BASK modulated differential bi-phase encoded data is typically performed by analog techniques such as envelope detection and envelope amplitude comparison post processing. These techniques are hardware intensive and during operation inductive coupling strengths between the coils may vary, which can affect the decoding accuracy. Also, noise may be induced into either or both of the coils, which can affect the signal amplitude levels thereby causing potential errors that may not be readily identified by analog demodulation and decoding techniques. Therefore, it would be advantageous to address these shortcomings in decoding of BASK modulated data.

### BRIEF DESCRIPTION OF THE DRAWINGS

The invention, together with objects and advantages thereof, may best be understood by reference to the following description of preferred embodiments together with the accompanying drawings in which:

FIG. 1 is a block diagram of an inductive charging station and associated inductively coupled chargeable unit in accordance with a preferred embodiment of the present invention;

FIG. 2 is a schematic block diagram of a BASK demodulator and decoder, which forms part of the inductive charging station of FIG. 1, in accordance with a preferred embodiment of the present invention;

FIG. 3 is a schematic circuit diagram of a biasing and filtering preprocessing module forming part of the demodulator and decoder of FIG. 2, in accordance with a preferred embodiment of the present invention;

FIG. 4 is a diagram of a waveform that is representative of a differential bi-phase encoded BASK modulated signal;

FIG. 5 is a waveform diagram in which the waveform is representative of a scaled, filtered and biased signal that is a preprocessed version of the differential bi-phase encoded BASK modulated signal;

FIG. 6A is a diagram of an example of a first filtered modulated digital signal created by the demodulator of FIG. 2, in accordance with a preferred embodiment of the present invention;

FIG. 6B is a diagram of an example of a second filtered modulated digital signal created by the demodulator of FIG. 2, in accordance with a preferred embodiment of the present invention;

FIG. 7 is a waveform diagram illustrating an example of data encoded in a prior art differential bi-phase encoded format;

FIG. 8 is a waveform diagram illustrating an example of data encoded in another prior art differential bi-phase encoded format; and

FIG. 9 is a flow chart of a method for decoding a BASK modulated signal in accordance with a preferred embodiment of the present invention.

### DETAILED DESCRIPTION OF PREFERRED EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the spirit and scope of the invention. In the drawings, like numerals are used to indicate like elements throughout. Furthermore, terms “comprises,” “comprising,” or any other variation thereof, are intended to cover a non-exclusive inclusion, such that module, circuit, device components, structures and method steps that comprises a list of elements or steps does not include only those elements but may include other elements or steps not expressly listed or inherent to such module, circuit, device components or steps. An element proceeded by “comprises . . . a” does not, without more constraints, preclude the existence of additional identical elements that comprises the element.

In one embodiment, the present invention provides a BASK demodulator and decoder for generating a plurality of Decoded Demodulated Binary Data Streams from a Binary Amplitude Key Shift Keying modulated signal that is modulated with a carrier frequency. The demodulator and decoder includes an analog to digital converter (ADC) having an analog signal sampling input, a sampling clock input and digital data output. The ADC samples a processed version of the modulated signal provided at the analog signal sampling input and provides digitized values thereof at the digital data output. In operation, a clock signal at the carrier signal is provided at the sampling clock input to synchronise sampling with the carrier signal. Ideally, the synchronised sampling coincides with an occurrence of peak amplitude values of the processed version of the modulated signal. There is a buffer having a buffer input coupled to the digital data output and a buffer output. In operation, the buffer stores the digitized values in a sequence order based on an order in which the peak amplitude values corresponding to the digitized values were sampled. A digital filter has a filter input that is coupled to the buffer output and a filter output. The digital filter is programmed to process the digitized values stored in the buffer using their sequence order to provide at least a first filtered modulated digital signal at the filter output. The demodulator and decoder also includes a data generator having a generator output and a generator input that is coupled to the filter output. The data generator is configured to configured to identify transitions of the first filtered modulated digital signal received at the generator input and based on the transitions generate at least one of the plurality of Decoded Demodulated Binary Data Streams at the generator output.

In another embodiment the present invention provides a method for demodulating a Binary Amplitude Key Shift Keying modulated signal. The method includes sampling peak amplitude values of a processed version of the modulated signal to provide sampled values and digitizing the sampled values to provide digitized values of processed version of the modulated signal. The digitized values are stored in a sequence order based on an order in which the peak amplitude values corresponding to the digitized values were sampled. The method also includes filtering the digitized values using their sequence order to provide at least a first filtered modulated digital signal, and then identifying transitions of the first filtered modulated digital signal. The method then generates at least one of a plurality of Decoded Demodulated Binary Data Streams based on the identifying.

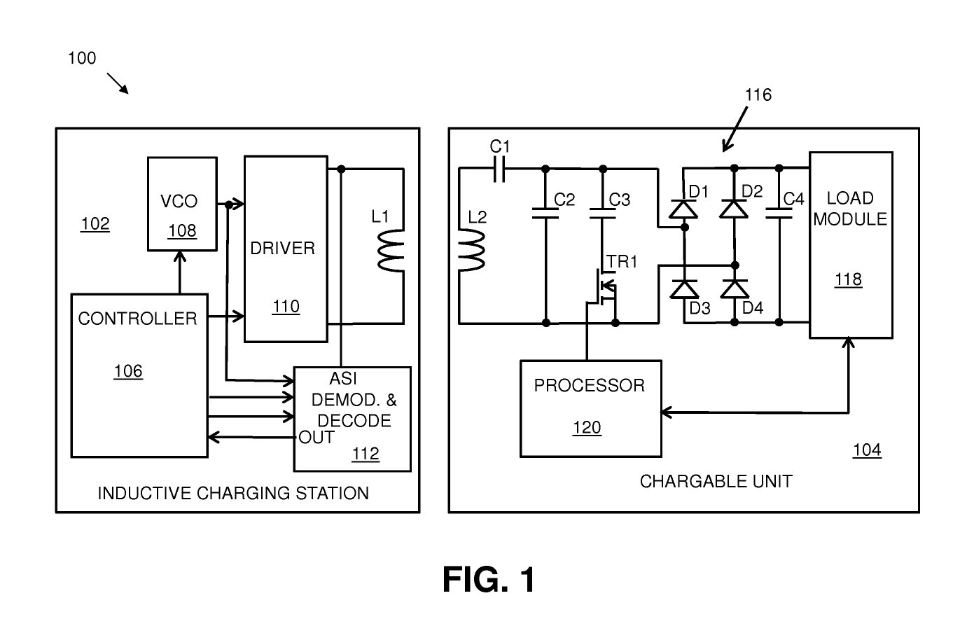

Referring to FIG. 1, a block diagram of a system 100 comprising an inductive charging station 102 and associated inductively coupled chargeable unit 104 in accordance with a preferred embodiment of the present invention is shown. The inductive charging station 102 has a controller 106 with outputs coupled to a voltage controlled oscillator (VCO) 108, a driver 110 and a combined demodulator and decoder 112.

In this embodiment the VCO 108 has an output that provides a sinusoidal carrier signal CS to an input of the driver 110. The sinusoidal signal CS has a carrier frequency FC, typically from 110 KHz to 205 KHZ, depending on control signals sent to from the controller 106 to the VCO 108. The controller 106 includes one or more input channels coupled an output port OUT of the demodulator and decoder 112 and the controller 108 has output lines coupled to inputs of the demodulator and decoder 112. The driver 110 includes a power amplifier circuit with output terminals coupled to a primary coil L1, and the primary coil L1 is also coupled to an analog signal input ASI of the demodulator and decoder 112.

The chargeable unit 104 has a secondary coil L2 that can be positioned to be inductively coupled to the primary coil L1. Coupled across output terminals of secondary coil L2 are series connected capacitors C1 and C2. There is also a series coupled transistor TR1 and a capacitor C3 is connected across capacitor C2. Also, connected across capacitor C2 is a bridge rectifier circuit 116 comprising four diodes D1, D2, D3 and D4. Outputs of the bridge rectifier circuit 116 are coupled to a load module 118 and a smoothing capacitor C4 is coupled across the outputs of the bridge rectifier circuit 116. The chargeable unit 104 also has a processor 120 coupled to the load module 118 and an output of the processor 120 is coupled to a gate of the transistor TR1.

The load module 118 includes a chargeable battery, the status of which is monitored by the processor 120. In operation, when the primary and secondary coils L1, L2 are in close proximity and inductively coupled together, the driver 110 provides power to the primary coil L1 at the carrier frequency FC which may vary between 110 KHz to 205 KHZ. Since the secondary coil L2 is inductively coupled to the primary coil, a voltage is induced at the output terminals of secondary coil L2 which provides a charging current to the load module 118. This charging current is rectified by the bridge rectifier circuit 116 and smoothed by the smoothing capacitor C4.

A backscatter BASK modulation technique is used by the system 100 to allow the chargeable unit 104 to communicate with the charging station 102 to typically, at least, provide a current battery charge status of the load module 118 and a suitable charging profile. This backscatter BASK modulation technique is achieved by the processor 120 sending pulsed control signals PCS, representing Data DA, to the gate of the transistor TR1 to selectively connect and disconnect the capacitor C3 across capacitor C2. The Data DA is encoded into differential bi-phase encoded symbols as will be apparent to a person skilled in the art.

The selective connecting and disconnecting of the capacitor C3 across capacitor C2 affects the voltage across the output terminals of secondary coil L2. In this embodiment, the Pulsed Control Signals PCS have a minimum duration of 500 uS which equates to a single Data Bit Duration DBD. The loading on the secondary coil L2 caused by connecting and disconnecting of the capacitor C3 across capacitor C2 affects the voltage across the inductively coupled primary coil L1. As a result of this loading, the voltage at the inductively coupled primary coil L1 varies in a manner dependent on Data DA represented by the Pulsed Control Signals PCS in a differential bi-phase encoded BASK modulated signal MSI. This differential bi-phase encoded BASK modulated signal MSI includes the Carrier Signal CS oscillating at the carrier frequency FC providing encoded data with the single Data Bit Duration DBD of 500 uS (i.e., a differential bi-phase encoded symbol duration).

The demodulator and decoder 112 demodulates and decodes the differential bi-phase encoded BASK modulated signal MSI to decode (replicate) the data DA encoded in the Modulated Signal MSI to generate a plurality of Decoded Demodulated Binary Data Streams DDBDS. The processor 106 may then send control signals to modify the output power of the driver 110 in response to the data DA received Decoded Demodulated Binary Data Streams DDBDS. Once the battery in the load module 118 is fully charged the chargeable unit 104, which can be any portable battery powered device, can be moved away from the charging station as will be apparent to a person skilled in the art.

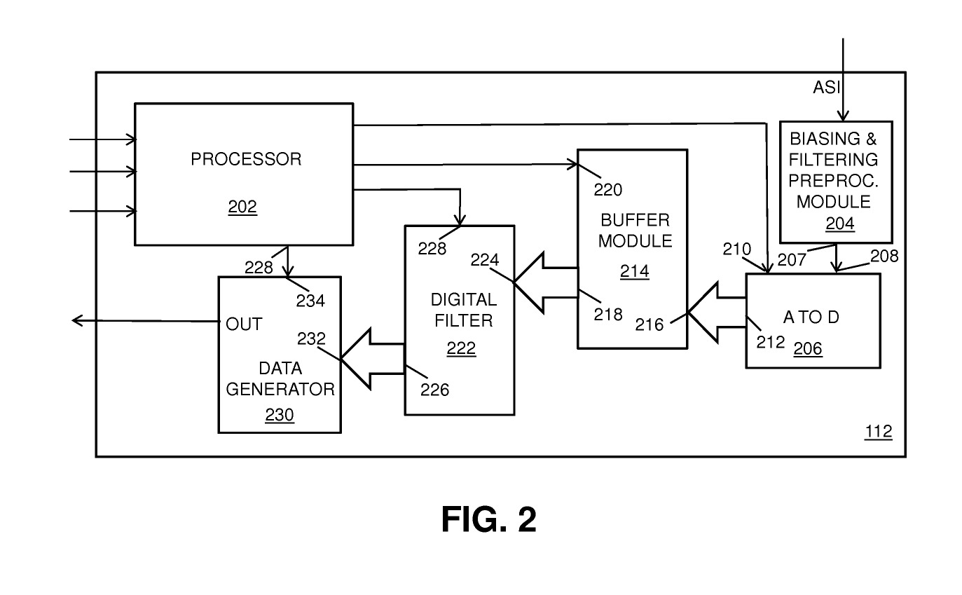

Referring to FIG. 2, a block diagram of the BASK demodulator and decoder 112, which forms part of the inductive charging station 102, in accordance with a preferred embodiment of the present invention, is shown. The BASK demodulator and decoder 112, in operation, generates at least one version of the Decoded Demodulated Binary Data Streams DDBDS from the differential bi-phase encoded BAS modulated Signal MSI that is modulated with the carrier frequency FC. The demodulator and decoder 112 includes a processor 202 with inputs coupled to the outputs of the controller 106 and an output of the voltage controlled oscillator 108. The demodulator and decoder 112 also comprises a biasing and filtering preprocessing module 204 with a preprocessed signal output 207 and an input that is the analog signal input ASI. In operation the preprocessing module 204 filters and biases the differential bi-phase encoded BASK modulated signal MSI with a biasing voltage Vbias to provide the pre-processed version of the differential bi-phase encoded BASK modulated Signal MSI.

There is also an analog to digital converter (ADC) 206 having an analog signal sampling input 208 coupled to the output 207 of the biasing and filtering preprocessing module 204, a sampling clock input 210 coupled to an output of the processor 202, and digital data output 212. The biasing and filtering preprocessing module 204 couples the analog signal sampling input 208 to the primary coil L1, and the ADC 206 is configured to sample the processed version of the modulated signal MSI provided at the analog signal sampling input 208. This processed version of the modulated signal MSI is provided by the biasing and filtering preprocessing module 204 which is digitized by the ADC 206. This provides digitized values DVAL of the processed version of the modulated signal MSI at the digital data output 212. In operation a clock signal CK at the carrier frequency FC of the carrier signal CS is provided at the sampling clock input 210 to synchronise sampling with the carrier signal. Ideally, this synchronised sampling coincides with the occurrence of peak amplitude values of the processed version of the modulated signal MSI. It will be appreciated that edges of the clock signal CK may be suitably offset from the peak values of the carrier signal CS to allow for inherent delays in the analog to digital converter 206.

The BASK demodulator and decoder 112 includes a buffer module 214 having a buffer input 216 coupled to the digital data output 212, a buffer output 218 and a control input 220 coupled to an output of the processor 202. In operation the buffer module 214 stores the digitized values DVAL from the analog to digital converter 206 in a sequence order SO based on an order in which the peak amplitude values corresponding to the digitized values DVAL were sampled by the ADC 206.

There is also a digital filter 222 having a filter input 224 coupled to the buffer output 218, a filter output 226 and a filter control input 228 coupled to an output of the processor 202. The digital filter 222 is programmed to process the digitized values DVAL stored in the buffer 214 using their sequence order SO to provide at least a first filtered modulated digital signal FFMS and a second filtered modulated digital signal SFMS at the filter output 226 (which are typically filter output ports).

The digital filter 222 is programmed to sequentially select one or more sliding windows comprising the digitized values DVAL in their sequence order SO and sum the digitized values DVAL in each of the windows to provide filtered discrete digital values that form the first filtered modulated digital signal FFMS and the second filtered modulated digital signal SFMS. More specifically, in one example each of the digitized values DVAL that are summed are adjacent in the sequence order SO to provide the first filtered modulated digital signal FFMS as shown in equation 1.

y(n)=Σₖ₌₀^{m-1}DVAL(n−k) (1);

where y(n) is a digital filtered value of one of the digitized values DVAL(n) and m is the window size which may be determined by: (FC/(1/DBD))/2. Thus, for a window size of m digitized values DVAL then y(0)=DVAL(0)+DVAL(1)+DVAL(2)+ . . . +Dval(m−1); y(1)=DVAL(1)+DVAL(2)+DVAL(3)+ . . . +Dval(m); and y(2)=DVAL(2)+DVAL(3)+DVAL(4)+ . . . +Dval(m+1) etc.

In contrast, the digital filter 222 calculates difference values between two adjacent windows to provide the second filtered modulated digital signal SFMS as shown in equation 2.

y(n)=Σₖ₌ₘ^{2m-1}DVAL(n−k)−Σₖ₌₀^{m-1}DVAL(n−k) (2);

where y(n) is a digital filtered value of one of the digitized values DVAL(n) and m is the window size which may be determined by: (FC/(1/DBD))/2. Thus, for a window size of m digitized values DVAL then y(0)=(DVAL(m)+DVAL(m+1)+DVAL(m+2)+ . . . +Dval(2m−1))−(DVAL(0)+DVAL(1)+DVAL(2)+ . . . +Dval(m−1)); and y(1)=(DVAL(m+1)+DVAL(m+2)+DVAL(m+3)+ . . . +Dval(2m))−(DVAL(1)+DVAL(2)+DVAL(3)+ . . . +Dval(m)) etc.

The demodulator and decoder 112 also comprises a data generator 230 having a generator output OUT (which is the output OUT of the demodulator and decoder 112) coupled to the controller 106. The data generator 230 also has a data generator input 232 coupled to the filter output 226, and a data generator control input 234 coupled to an output of the processor 202. The data generator 230 is configured to identify transitions TR of the first filtered modulated digital signal received at the generator input 232, and based on the transitions generate at least one of the plurality of Decoded Demodulated Binary Data Streams at the generator output OUT.

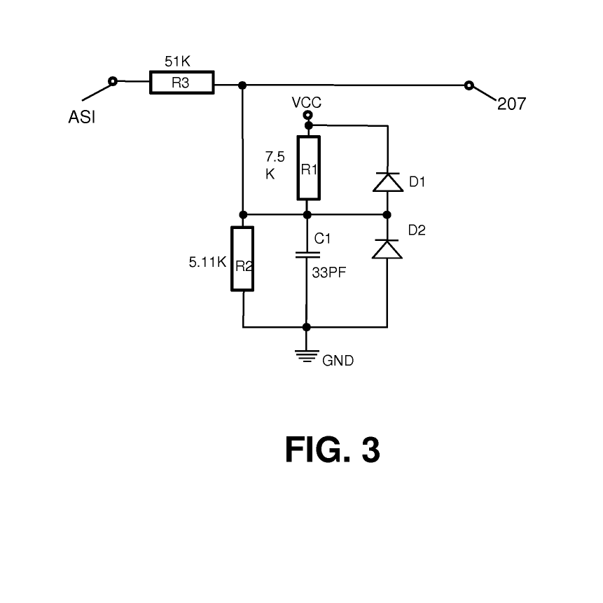

Referring to FIG. 3, a schematic circuit diagram of the biasing and filtering preprocessing module 204, in accordance with a preferred embodiment of the present invention, is shown. The biasing and filtering preprocessing module 204 includes two series connected resistors R1,R2 coupled across a supply rail VCC and ground rail GND. There are also two series connected reversed biased diodes D1,D2 coupled across the supply rail VCC and ground rail GND. An anode of diode D2 is coupled to the ground rail GND and a cathode of diode D1 is coupled to the supply rail VCC. The cathode of diode D2 and anode of diode D1 are coupled to the preprocessed signal output 207. There is a capacitor C1 coupled across the resistor R2 and the diode D2. There is also a resistor R3 is coupled in series between the analog signal input ASI and the preprocessed signal output 207.

The resistor R3 and capacitor C1 have values that provide a low pass filter to thus remove high frequency noise components from signals received at the analog signal input ASI. The diodes D1 and D2 limit the amplitude values of signals at the preprocessed signal output 207 to the rail values of VCC and GND. Also, the values of the resistors R1, R2 provide the biasing voltage Vbias of any signals provide at the preprocessed signal output 207. In this example Vbias is equal to (VCC/(R1+R2))*R2=VCC/(7.5K+5.11)*5.11K=0.41*VCC.

Referring to FIG. 4, there is illustrated a diagram of a waveform that is representative of a differential bi-phase encoded BASK modulated signal MSI. This differential bi-phase encoded BASK modulated signal MSI is formed from the Carrier Signal CS oscillating at the carrier frequency FC (110 KHz to 205 KHZ), which is the amplitude modulated binary Data DA with a single Data Bit Duration DBD of 500 uS (symbol period). The carrier signal CS has a period T (where T=1/FC) that is amplitude modulated between a high state and a low state. As will be apparent to a person skilled in the art, in operation the actual maximum amplitudes for the high state and low state conditions of the differential bi-phase encoded BASK modulated signal MSI may vary. This is because the inductive coupling strengths between the coils L1, L2 may vary and noise may be induced into the coils L1, L2.

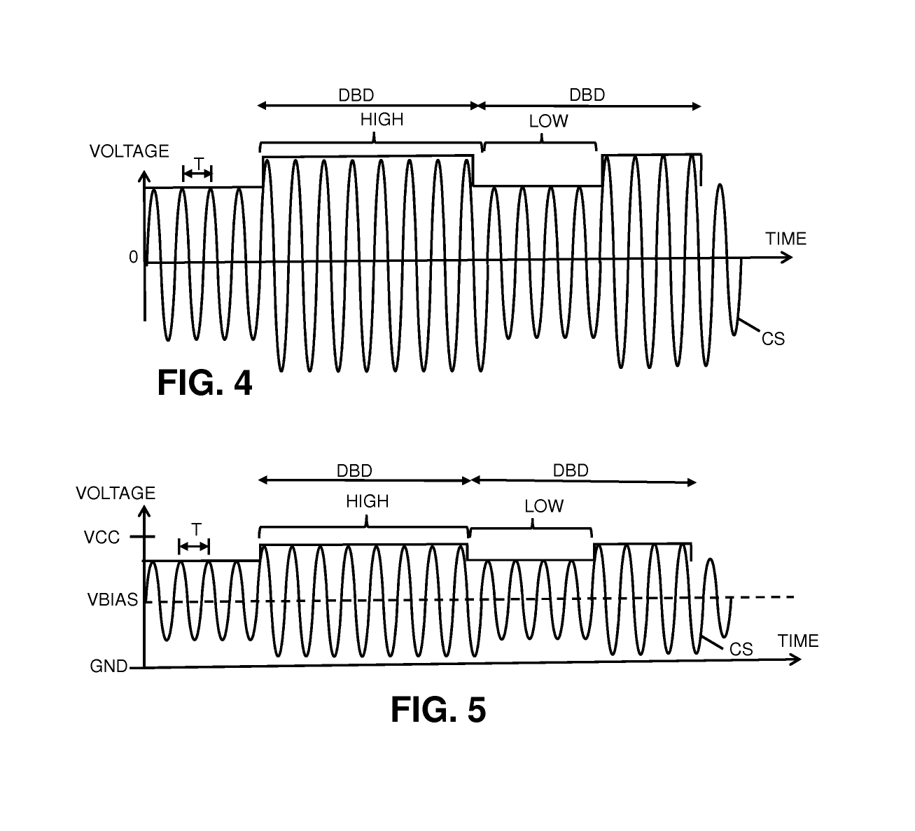

Referring to FIG. 5, there is illustrated a diagram of a a waveform that is representative of a scaled, filtered and biased signal which is the preprocessed version of the differential bi-phase encoded Binary Amplitude Shift Keying Modulated Signal MSI provided at the preprocessed signal output 207. In this example the DC bias voltage VBIAS is 0.41*VCC however other values may also be used.

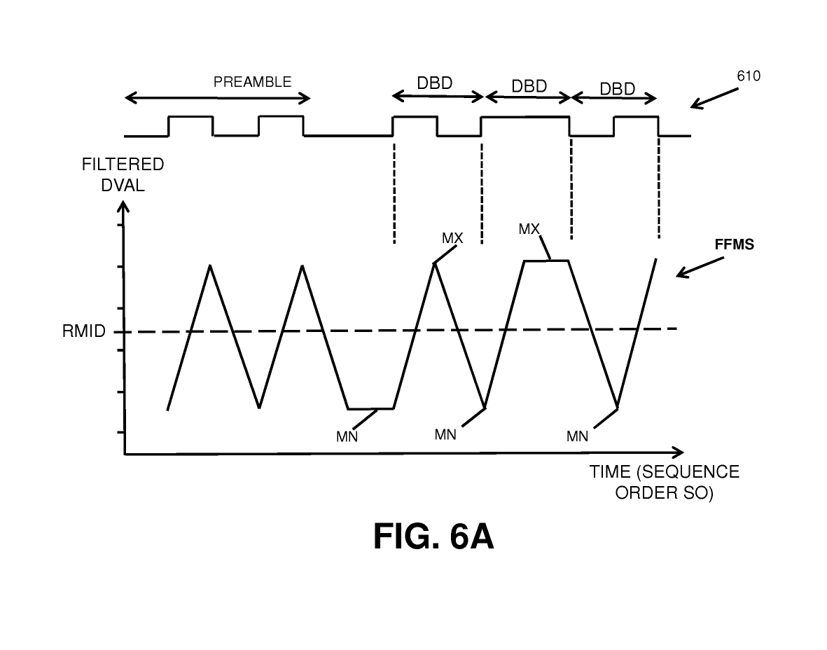

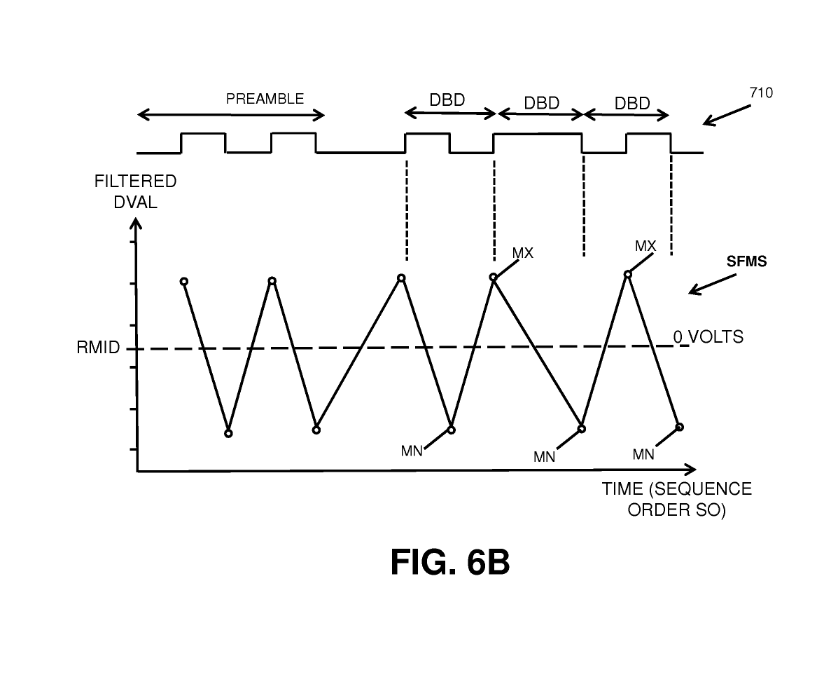

Referring to FIG. 6A there is illustrated a diagram of an example of the first filtered modulated digital signal FFMS provided at the filter output 226, in accordance with a preferred embodiment of the present invention. This example of the first filtered modulated digital signal FFMS is formed from the individual digital filtered values y(n) in their stored sequence order SO. For ease of explanation, part of a packet of differential bi-phase encoded data 610 is shown. The first filtered modulated digital signal FFMS is representative of the differential bi-phase encoded data 610 and will be used for ease of explanation. The differential bi-phase encoded data 610 includes preamble timing pulses and symbols in data bit durations DBD. Also shown, is a mid-point reference value RMID half way between expected minimum (MIN) and maximum (MAX) values of the digital filtered values y(n). This mid-point value RMID is one of the transitions TR. Typically this mid-point reference value RMID is equal to the biasing voltage Vbias. The data generator 230 uses the references value RMID in combination with the first filtered modulated digital signals FFMS to generate decoded data. More specifically, the data generator 230 creates two channels (channel 1 and channel 2) providing two of the plurality of Decoded Demodulated Binary Data Streams DDBDS.

The data generator 230 is configured to generate channel 1 with the first filtered modulated digital signal FFMS such that after the commencement of a data bit duration DBD only one transition across the mid-point value RMID is detected in the remainder of the data bit duration DBD then, the data generator 230 generates a first binary value (e.g., a logic zero) for the data bit duration DBD. However, if two transitions across the mid-point value RMID are detected in the remainder of the data bit duration DBD, then the data generator 230 generates an opposite second binary value (e.g., a logic one) for the data bit duration DBD. The first and opposite second binary values are then simply provided as one of the Decoded Demodulated Binary Data Streams DDBDS where each binary value has a period of one data bit duration DBD.

The data generator 230 is configured to generate channel 2 with the first filtered modulated digital signal FFMS. The data generator 230 detects the end of the preamble (a sequence of half data bit durations high/low transitions ending in a low logic pulse for a complete data bit duration DBD) thereafter the min (MN) and max (MX) values of the first filtered modulated digital signal FFMS are identified as the transitions TR. If after the commencement of a data bit duration DBD only one min (MN) or one max transition TR is identified in the remainder of the data bit duration DBD, then the data generator 230 generates a first binary value (e.g., a logic zero) for the data bit duration. However, if both a min (MN) and a max (MX) transition TR are detected in the remainder of the data bit duration DBD, then the data generator 230 generates an opposite second binary value (e.g., a logic one) for the data bit duration DBD. The first and opposite second binary values are then simply provided as one of the Decoded Demodulated Binary Data Streams DDBDS where each binary value has a period of one data bit duration DBD.

Referring to FIG. 6B, there is illustrated a diagram of an example of the second filtered modulated digital signal SFMS provided at the filter output 226, in accordance with a preferred embodiment of the present invention. Again, this example of the second filtered modulated digital signal SFMS is formed from individual digital filtered values y(n) in their stored sequence order SO. For ease of explanation, part of a packet of differential bi-phase encoded data 710 is again shown. The second filtered modulated digital signal SFMS is representative of the differential bi-phase encoded data 710 and will be used for ease of explanation. In this embodiment the mid-point reference value RMID half way between expected minimum (MIN) and maximum (MAX) values of the digital filtered values y(n). Again, this mid-point reference value RMID is typically equal to the biasing voltage Vbias. The data generator 230 uses the references value RMID in combination with the second filtered modulated digital signals SFMS to generate decoded data. More specifically, the data generator 230 creates a further two channels (channel 3 and channel 4) providing two of the plurality of Decoded Demodulated Binary Data Streams DDBDS.

The data generator 230 is configured to generate channel 3 with the second filtered modulated digital signal SFMS such that when after the commencement of a data bit duration DBD only one transition across the mid-point value RMID is detected in the remainder of the data bit duration DBD then, the data generator 230 generates a first binary value (e.g. a logic zero) for the data bit duration DBD. However, if two transitions across the mid-point value RMID are detected in the remainder of the data bit duration DBD, then the data generator 230 generates an opposite second binary value (e.g., a logic one) for the data bit duration DBD. The first and opposite second binary values are then simply provided as one of the Decoded Demodulated Binary Data Streams DDBDS where each binary value has a period of one data bit duration DBD.

The data generator 230 is configured to generate channel 4 with the second filtered modulated digital signal SFMS. The data generator 230 detects the end of the preamble (a sequence of half data bit durations high/low transitions ending in a low logic pulse for a complete data bit duration DBD) thereafter the min (MN) and max (MX) values of the second filtered modulated digital signal SFMS are identified as the transitions TR. If after the commencement of a data bit duration DBD only one min (MN) or one max transition TR is identified in the remainder of the data bit duration DBD, then the data generator 230 generates a first binary value (e.g., a logic zero) for the data bit duration DBD. However, if both a min (MN) and a max (MX) transition TR are detected in the remainder of the data bit duration DBD, then the data generator 230 generates an opposite second binary value (e.g., a logic one) for the data bit duration. The first and opposite second binary values are then simply provided as one of the Decoded Demodulated Binary Data Streams DDBDS where each binary value has a period of one data bit duration DBD.

In operation the controller 106 selectively processes versions of the Decoded Binary Demodulated Data DBDD, provided at the channels 1 to 4, by using check sums to determine the accuracy of the data. This selectively processing can be by simply by in pre-defined order such that channel 1 is selected first and processed. If when error checking, by the controller 106, detects errors in the decoded version, channel 4 is then selected and error checking is performed again. Again if errors are detected channel 2 or 3 may be selected next.

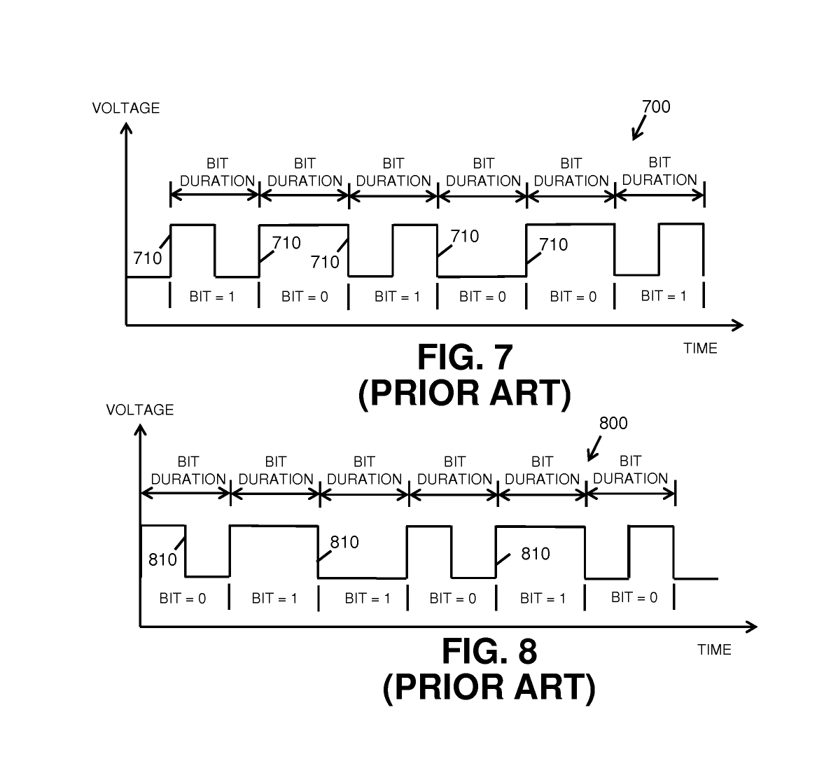

Referring to FIG. 7, there is shown a waveform diagram illustrating data encoded in a prior art differential bi-phase encoded format 700 processed by the demodulator and decoder 112. The coded format 700 includes encoded sequential data bits with pre-defined individual data bit durations (BIT DURATION) bounded by binary logic state transitions 710.

There are two encoded logic values in the encoded format 700 in which individual data bit durations that have a continuous binary logic state of zero or one are encoded as a first logic value (BIT=0) which is a logic value 0. In contrast, individual data bit durations that have more than one binary logic state of both zero and one are encoded as a second logic value (BIT=1) which is a logic value 1. Thus, the data bit durations that have more than one binary logic state spend 50% of a bit duration at logic state 1 and 50% of a bit duration at logic state 0.

Referring to FIG. 8, a waveform diagram of an example of data encoded in a prior art differential bi-phase encoded format 800 processed by the demodulator and decoder 112 is shown. The coded format 800 includes encoded sequential data bits with pre-defined individual data bit durations (BIT DURATION) bounded by binary logic state transitions 810.

There are two encoded logic values in the coded format 800 in which individual data bit durations that have a continuous binary logic state of zero or one are encoded as a first logic value (BIT=1) which is a logic value 1. In contrast, individual data bit durations that have more than one binary logic state of both zero and one are encoded as a second logic value (BIT=0) which is a logic value 0. Thus, the data bit durations that have more than one binary logic state spend 50% of a bit duration at logic state 1 and 50% of a bit duration at logic state 0.

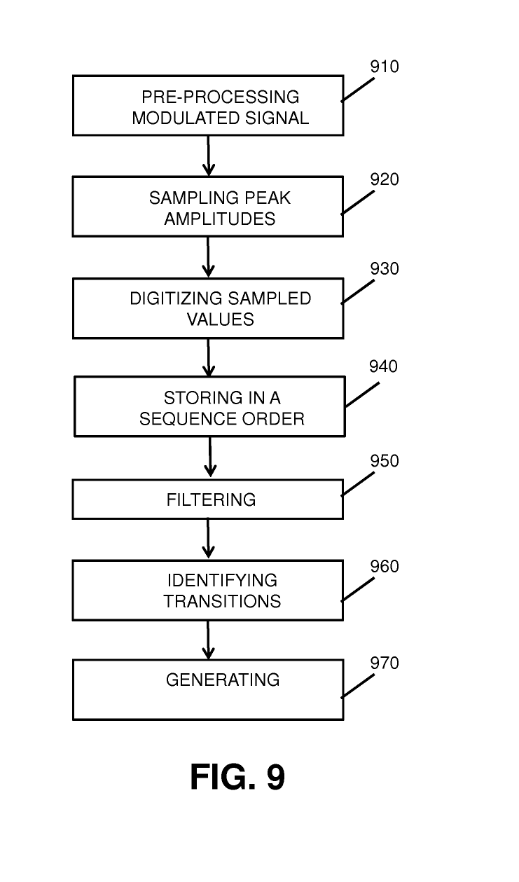

FIG. 9 is a flow chart illustrating a method 900 for decoding a differential bi-phase encoded Binary Amplitude Key Shift Keying modulated signal, in accordance with a preferred embodiment of the present invention. By way of example the method will be illustrated with reference to the demodulator and decoder 112. The method 900 includes a pre-processing block 910 that pre-processes the differential bi-phase encoded BASK modulated signal MSI by filtering and biasing with the biasing voltage Vbias as provided by module 204. At a sampling block 920, there is performed a process of sampling peak amplitude values of a processed version of the modulated signal to provide sampled values that are digitized, at block 930, to provide the digitized values DVAL of processed version of the modulated signal. These digitized values DVAL are provided at the digital data output 212 and at a block 940 the buffer module 214 stores the digitized values DVAL in the sequence order SO based on an order in which the peak amplitude values corresponding to the digitized values were sampled.

At a filtering block 950, the digital filter 222 performs filtering the digitized values DVAL using their sequence order SO to provide at least the first filtered modulated digital signal FFMS. The filtering sequentially selects windows comprising the digitized values DVAL in their sequence order SO. The filtering sums the digitized values DVAL in each of the windows to provide the filtered discrete digital values that form the first filtered modulated digital signal FFMS, and the second filtered modulated digital signal SFMS. Each of the digitized values DVAL that are summed are adjacent in the sequence order SO to provide the first filtered modulated digital signal and the filtering calculates difference values between two adjacent windows to provide the second filtered modulated digital signal.

At An identifying block 960 the a data generator 230 identifies the transitions TR as described above and a generating block 970 generates the least one of a plurality of Decoded Demodulated Binary Data Streams DDBDS based on an outcome of the identifying block 960 as described above.

As will be apparent to a person skilled in the art, blocks 950 to 970 also perform operations on the second filtered modulated digital signal SFMS to generate one or more Decoded Demodulated Binary Data Streams DDBDS.

Advantageously, the present invention at least alleviates the expense of analog decoders and the potential errors that may occur when demodulating and decoding varying signal amplitudes in backscatter modulated data. These varying signal amplitudes are typically caused by variations in inductive coupling strengths of the coils L1, L2 or noise that is induced into the coils L1, L2.

The description of the preferred embodiments of the present invention has been presented for purposes of illustration and description, but is not intended to be exhaustive or to limit the invention to the forms disclosed. It will be appreciated by those skilled in the art that changes could be made to the embodiments described above without departing from the broad inventive concept thereof. It is understood, therefore, that this invention is not limited to the particular embodiment disclosed, but covers modifications within the spirit and scope of the present invention as defined by the appended claims.

1. A Binary Amplitude Shift Keying (BASK) demodulator and decoder for generating a plurality of decoded demodulated binary data streams from a BASK modulated signal that is modulated with a carrier signal, the demodulator and decoder comprising:
an analog to digital converter (ADC) having an analog signal sampling input, a sampling clock input and digital data output, wherein the ADC samples a processed version of the modulated signal provided at the analog signal sampling input and provides digitized values thereof at the digital data output, and wherein in operation a clock signal at a carrier frequency of the carrier signal is provided at the sampling clock input to synchronise sampling with the carrier signal;
a buffer having a buffer input coupled to the digital data output and a buffer output, wherein in operation the buffer stores the digitized values in a sequence order based on an order in which the peak amplitude values corresponding to the digitized values were sampled;
a digital filter having a filter input coupled to the buffer output and a filter output, wherein the digital filter is programmed to process the digitized values stored in the buffer using their sequence order to provide at least a first filtered modulated digital signal at the filter output; and
a data generator having a generator output and a generator input that is coupled to the filter output, wherein the data generator identifies transitions of the first filtered modulated digital signal received at the generator input and based on the transitions generates at least one of the plurality of decoded demodulated binary data streams at the generator output.

2. The BASK demodulator and decoder of claim 1, further comprising a preprocessing module coupling the analog signal sampling input to a coil, wherein in operation the preprocessing module filters and biases the BASK modulated signal with a biasing voltage to provide the pre-processed modified version thereof.

3. The BASK demodulator and decoder of claim 1, wherein one of the transitions is identified with a mid-point value half way between expected minimum and maximum values of the first filtered modulated digital signal, and wherein the data generator is configured such that after the commencement of a data bit duration only one transition across the mid-point value is detected in the remainder of the data bit duration DBD then the data generator generates a first binary value for the data bit duration.

4. The BASK demodulator and decoder of claim 3, wherein the data generator is configured such that if after the commencement of a data bit duration two transitions across the mid-point value are detected in the remainder of the data bit duration, the data generator generates an opposite second binary value for the data bit duration.

5. The BASK demodulator and decoder of claim 4, wherein the mid-point value is equal to the biasing voltage.

6. The BASK demodulator and decoder of claim 4, wherein the digital filter is programmed to sequentially select windows comprising the digital filtered values in their sequence order and sum the digital filtered values in each of the windows to provide filtered discrete digital values that form the first filtered modulated digital signal and a second filtered modulated digital signal.

7. The BASK demodulator and decoder of claim 6, wherein each of the digital filtered values that are summed are adjacent in the sequence order to provide the first filtered modulated digital signal.

8. The BASK demodulator and decoder of claim 7, wherein the digital filter is further programmed calculate difference values between two adjacent said windows to provide the second filtered modulated digital signal.

9. The BASK demodulator and decoder of claim 1, wherein the transitions are minimum and maximum value transitions and the data generator is configured such that if after the commencement of a data bit duration only one minimum or one maximum transition is identified in the remainder of the data bit duration, then the data generator generates a first binary value for the data bit duration DBD.

10. The BASK demodulator and decoder of claim 1, wherein when both a minimum and a maximum transition TR are detected in the remainder of the data bit duration, then the data generator generates an opposite second binary value for the data bit duration DBD.

11. A method for decoding a BASK modulated signal, the method comprising:
sampling peak amplitude values of a pre-processed version of the modulated signal to provide sampled values;
digitizing the sampled values to provide digitized values of processed version of the modulated signal;
storing the digitized values in a sequence order based on an order in which the peak amplitude values corresponding to the digitized values were sampled;
filtering the digitized values using their sequence order to provide at least a first filtered modulated digital signal;
identifying transitions of the first filtered modulated digital signal; and
generating at least one of a plurality of decoded demodulated binary data streams based on the identified transitions.

12. The method of claim 11, further comprising pre-processing the modulated-signal to provide the pre-processed version of the modulated signal, the pre-processed version being a filtered and biased version of the BASK modulated signal.

13. The method of claim 11, wherein one of the transitions is identified with a mid-point value half way between expected minimum and maximum values of the first filtered modulated digital signal, and wherein after the commencement of a data bit duration only one transition across the mid-point value is detected in the remainder of the data bit duration then the data generator generates a first binary value for the data bit duration.

14. The method of claim 13, wherein after the commencement of a data bit duration two transitions across the mid-point value are detected in the remainder of the data bit duration, the data generator generates an opposite second binary value for the data bit duration.

15. The method of claim 14, wherein the filtering sequentially selects windows comprising the digitized values in their sequence order and sums the digitized values in each of the windows to provide filtered discrete digital values that form the first filtered modulated digital signal and a second filtered modulated digital signal.

16. The method of claim 15, wherein each of the digitized values that are summed are adjacent in the sequence order to provide the first filtered modulated digital signal.

17. The method of claim 16, wherein the filtering calculates difference values between two adjacent said windows to provide the second filtered modulated digital signal.

18. The method of claim 11, wherein the transitions are minimum and maximum value transitions and wherein after the commencement of a data bit if only one minimum or one maximum transition is identified in the remainder of the data bit duration, then the a first binary value is generated for the data bit duration DBD.

19. The method of claim 11, wherein when both a minimum and a maximum transition TR are detected in the remainder of the data bit duration, an opposite second binary value is generated for the data bit duration DBD.

20. The method of claim 11, wherein data in the Binary Amplitude Key Shift Keying modulated signal is encoded as differential a bi-phase encoding.
